(19) United States
(12) Patent Application Publication
(10) Pub. No.: US 2024/0046331 A1
(43) Pub. Date: Feb. 8, 2024

(54) VEHICLE RECOMMENDATION SYSTEM

(71) Applicants: Hyundai Motor Company, Seoul (KR); Kia Corporation, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(21) Appl. No.: 18/364,065

(22) Filed: Aug. 2, 2023

(30) Foreign Application Priority Data
Aug. 5, 2022 (KR) 10-2022-0097700

(51) Int. Cl. G06Q 30/0601

(52) U.S. Cl. CPC G06Q 30/0631; G06Q 30/0627

(57) ABSTRACT

A vehicle recommendation system according to an embodiment includes a user tendency determiner configured to determine a user tendency and a trim tendency of a user corresponding to the user tendency based on a response to a user tendency test received from a user terminal. An embodiment can include a price index calculation unit configured to derive a price index of each vehicle based on a price of each vehicle and a vehicle purchase budget of the user. An embodiment can include an optimal tendency matcher configured to derive vehicles each conforming the trim tendency of the user and having the price index equal to or greater than a predetermined critical price index based on at least the trim tendency of the user and the price index. The plurality of candidate vehicles can include a vehicle to be determined whether it is suitable for recommendation to the user as a purchase vehicle.

### CROSS-REFERENCE TO RELATED APPLICATIONS

This application claims the benefit of Korean Patent Application No. 10-2022-0097700, filed on Aug. 5, 2022, which application is hereby incorporated herein by reference.

### TECHNICAL FIELD

The present disclosure relates to a vehicle recommendation system.

### BACKGROUND

Customers who do not know much about cars find it difficult to use a vehicle recommendation service provided by a vehicle manufacturer. For example, in a vehicle recommendation service application provided through the web, various questions requesting a response from a customer who wants to purchase a vehicle are specialized questions about vehicles that are difficult for the customer to understand. Moreover, customer satisfaction with a vehicle recommendation result provided to the customer based on the response to the corresponding question is low. As described above, the corresponding application has been developed and provided according to the need for the vehicle recommendation service, but it is difficult for customers to use the vehicle recommendation service through the corresponding application, and satisfaction with the vehicle recommendation result is low.

In addition, when a vehicle is purchased online, a vehicle purchase process is very complicated. Due to the complicated vehicle purchase process, a user selects a vehicle by mistake, which causes inconvenience to the user in purchasing a vehicle. The online vehicle purchase method of the related art is implemented as a dealer-centered platform that sells vehicles rather than a platform for users.

### SUMMARY

Embodiments of the present disclosure include a system and method capable of recommending an optimal vehicle that satisfies a user who wants to purchase a vehicle.

An embodiment of the present disclosure provides a vehicle recommendation system including a user tendency determiner configured to determine a user tendency and a trim tendency of a user corresponding to the user tendency based on a response to a user tendency test received from a user terminal. An embodiment also includes a price index calculation unit configured to, with respect to a plurality of vehicles, derive a price index of each vehicle based on a price of each vehicle and a vehicle purchase budget of the user. An embodiment also includes an optimal tendency matcher configured to derive, as a plurality of candidate vehicles, vehicles each conforming the trim tendency of the user and having the price index equal to or greater than a predetermined critical price index, among the plurality of vehicles, based on at least the trim tendency of the user and the price index.

The plurality of candidate vehicles can include a vehicle to be determined whether it is suitable for recommendation to the user as a purchase vehicle.

The optimal tendency matcher can derive the plurality of candidate vehicles based on an estimated number of passengers together with the trim tendency of the user and the price index, and the estimated number of passengers can be received from the user terminal.

The optimal tendency matcher can include a leveling index calculator configured to calculate a plurality of leveling indexes for leveling a plurality of indexes of a plurality of vehicle tendency elements of each candidate vehicle with respect to the plurality of candidate vehicles.

The optimal tendency matcher can further include a matching index calculator configured to calculate a tendency matching index, which can include a matching index between a result of applying a plurality of leveling indexes to a vehicle tendency of each candidate vehicle with respect to the plurality of candidate vehicles and the user tendency.

The matching index calculator can calculate a plurality of fourth indexes by correspondingly multiplying a plurality of third indexes, obtained by multiplying the plurality of leveling indexes by a plurality of second indexes for a plurality of vehicle tendency elements corresponding to the vehicle tendency of each candidate vehicle, by a plurality of first indexes for a plurality of user tendency elements corresponding to the user tendency.

The optimal tendency matcher can further include a weight applicator configured to calculate a tendency matching index by applying at least one weight according to each candidate vehicle with respect to a plurality of candidate vehicles to the plurality of fourth indexes of each candidate vehicle.

The weight applicator can apply a weight according to a trim tendency of each candidate vehicle with respect to the plurality of candidate vehicles to the fourth index of the corresponding vehicle tendency element among the plurality of fourth indexes of each candidate vehicle.

The weight applicator can calculate a total index by summing the plurality of fourth indexes to which the weight according to the trim tendency of each candidate vehicle is applied with respect to the plurality of candidate vehicles.

The weight applicator can calculate the tendency matching index by adding a camping factor index and a passenger factor index to the total index, the camping factor index can be an index set when each candidate vehicle is a vehicle suitable for camping, and the passenger factor index can be an index set according to the number of passengers ridable in each candidate vehicle.

The optimal tendency matcher can determine a plurality of purchase target vehicles based on a tendency matching index indicating a degree of matching between the user tendency and the vehicle tendency of each of the plurality of candidate vehicles.

The vehicle recommendation system can further include a car master selector configured to identify a plurality of candidate car masters selling a purchase target vehicle selected through the user terminal among the plurality of candidate car masters, and select a final car master suitable for the user from among the plurality of candidate car masters.

The car master selector can select the final car master using a tendency matching method of selecting a car master conforming the user tendency, a distance reference method of selecting a car master located within a certain distance with respect to a user location, a customer evaluation reference method of selecting a car master of which evaluation score based on a customer evaluation is equal to or greater than a predetermined reference score, or any combination thereof.

The car master selector can calculate a standard deviation of a difference between the plurality of tendency elements of each candidate car master and the plurality of tendency elements of the user with respect to the plurality of candidate car masters according to the tendency matching method and select a car master corresponding to a smallest standard deviation among a plurality of standard deviations as the final car master.

The vehicle recommendation system can further include a car master tendency determiner configured to receive a response to a car master tendency test from a car master terminal and determine a car master tendency based on the received response.

The car master selector can select a candidate car master located within a predetermined reference distance from among a plurality of candidate car masters as a final car master with respect to a location designated by the user according to the distance reference method.

The car master selector can calculate an evaluation score based on customer evaluations of the plurality of candidate car masters, and select a candidate car master of which evaluation score is equal to or higher than a predetermined reference score as a final car master according to the customer evaluation reference method.

The vehicle recommendation system can charge a corresponding fee for a test drive service, a vehicle contract service, a vehicle delivery service from the final car master, or any combination thereof.

The vehicle recommendation system can further include a fee calculator configured to calculate a fee for a service provided to a user from the final car master, and the fee calculator can calculate a fee ratio between two services linked based on a linkage ratio between the two services that are linked among the test drive service, the vehicle contract service, and the vehicle delivery service.

The fee calculator can reduce a test drive service fee and a vehicle contract service fee based on a first linkage ratio between the test drive service and the vehicle contract service of each of the plurality of car masters, and reduce the vehicle contract service fee and a vehicle delivery service fee based on a second linkage ratio between the vehicle contract service and the vehicle delivery service.

As the first linkage ratio increases, a range of reduction of each of the test drive service fee and the vehicle contract service fee can increase, and as the second linkage ratio increases, a range of reduction of each of the vehicle contract service fee and vehicle release service fee can increase.

The vehicle recommendation system can further include an age index calculator configured to derive an age index for an age of a user predicted to purchase each vehicle with respect to the plurality of vehicles in consideration of a segment, a brand, a type, and an energy source of each vehicle.

The user tendency determiner can calculate an age preference index of a user according to an average of indexes for the plurality of tendency elements of the user.

The optimal tendency matcher can calculate a degree of matching between the user and each of the plurality of candidate vehicles in consideration of the age index and the age preference index for the plurality of candidate vehicles.

An embodiment of the present disclosure can provide the vehicle recommendation system capable of determining a vehicle suitable for the tendency of a user to purchase a vehicle and providing a vehicle delivery service to the user.

### BRIEF DESCRIPTION OF THE DRAWINGS

FIG. 1 is a diagram illustrating a vehicle recommendation system according to an embodiment.

FIG. 2 is a diagram illustrating the configuration of a user tendency determiner according to an embodiment.

FIG. 3 is a graph for explaining a method, performed by a price index calculator, of determining a price index through proportional calculation according to an embodiment.

FIG. 4 is a graph for explaining a method, performed by a price index calculator, of determining a price index through clustering according to an embodiment.

FIG. 5 is a diagram illustrating an optimal tendency matcher according to an embodiment.

FIG. 6 is a diagram illustrating a part of a vehicle recommendation system according to an embodiment.

FIG. 7 is a diagram illustrating some configurations of a vehicle recommendation system according to an embodiment.

### DETAILED DESCRIPTION OF ILLUSTRATIVE EMBODIMENTS

In embodiments of the present disclosure, a vehicle list suitable for a user can be generated in consideration of a vehicle tendency and a user tendency, and information about a car master owning a vehicle selected by the user from the vehicle list can be provided to the user. The user can select a car master from which to purchase a vehicle based on the provided information about the car master, and in an embodiment of the present disclosure, a fee for the car master selected by the user can be charged.

Hereinafter, embodiments disclosed in the present specification will be described in detail with reference to the accompanying drawings, but same or similar components are given the same or similar reference numerals, and redundant descriptions thereof may be omitted. The suffixes “module” and/or “part” for components used in the following description are given or mixed in consideration of only the ease of drafting the specification, and do not necessarily have meanings or roles distinct from each other by themselves. In addition, in describing embodiments disclosed in the present specification, when it is determined that detailed descriptions of related known technologies can obscure the gist of the embodiments disclosed in the present specification, the detailed description thereof may be omitted. In addition, the accompanying drawings are only for easy understanding of embodiments disclosed in the present specification, do not limit the technical ideas disclosed in the present specification, and should be understood to include all changes, equivalents, or substitutes included in the spirit and scope of the present disclosure.

Terms including an ordinal number, such as first, second, etc., can be used to describe various components, but the components are not necessarily limited by the terms. These terms can be used only for the purpose of distinguishing one component from another.

It can be understood that when a component is referred to as being “connected to” or “coupled to” another component, the component can be connected or coupled to the other component or intervening components can be present. In contrast, when a component is referred to as being “directly connected to” or “directly coupled to” another component, there are no intervening components present.

It can be further understood that the terms “comprises” and/or “comprising,” when used in the present specification, specify the presence of stated features, integers, steps, operations, components, and/or parts, but do not preclude the presence or addition of one or more other features, integers, steps, operations, components, parts, and/or combinations thereof.

In addition, the terms “-er” described in the specification can be implemented by hardware components or software components stored in memory, and combinations thereof.

In the following specification, transmitting and receiving information between one component and another component through a network can include a communication device transmitting information received from one component to another component through a network, and transferring information received from another component through a network to one component.

Hereinafter, in the specification, user tendency can include personal tendencies that can be considered when a vehicle is purchased among various personal tendencies. Each of personal tendencies can be referred to as a user tendency element. In the specification, vehicle tendency can include qualitative characteristics of a vehicle corresponding to the user tendency. The vehicle tendency can include a plurality of vehicle tendency elements respectively corresponding to a plurality of user tendency elements. In the context of the present disclosure, a user can refer to a customer who wants to be recommended a vehicle using a vehicle recommendation system according to an embodiment.

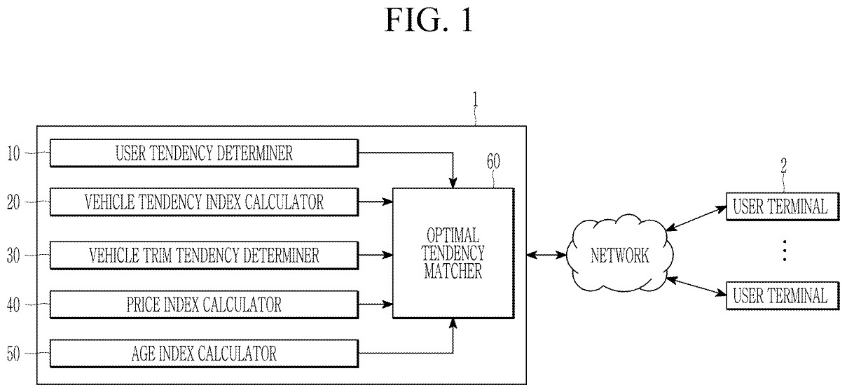

First, an embodiment of a vehicle recommendation system will be described with reference to FIG. 1.

FIG. 1 is a diagram illustrating a vehicle recommendation system according to an embodiment.

A vehicle recommendation system 1 can include a user tendency determiner 10, a vehicle tendency index calculator 20, a vehicle trim tendency determiner 30, a price index calculator 40, an age index calculator 50, and an optimal tendency matcher 60.

The vehicle recommendation system 1 can transmit/receive information with a plurality of user terminals 2 through a network. Although not shown in FIG. 1, the vehicle recommendation system 1 can receive necessary information for vehicle recommendation from an external server through a network. In FIG. 1, all the components 10 to 40 are included in the vehicle recommendation system 1, but some of the components 10 to 40 can be implemented outside, and transmit/receive necessary information for vehicle recommendation with the other components through a network. The vehicle recommendation system 1 can store software including a program for performing an operation according to an embodiment, and operate the program. Functions performed according to the operation of the program can be classified into respective operations of the user tendency determiner 10, the vehicle tendency index calculator 20, the optimal tendency matcher 60, and the price index calculator 40.

The vehicle recommendation system 1 according to an embodiment can include the user tendency determiner 10.

The user tendency determiner 10 can transmit to a user terminal 2 a question for a user (hereinafter referred to as a user question) for recommending a vehicle suitable for the user and a user tendency test including questions for determining a user tendency. The user tendency determiner 10 can receive responses to the user question and the user tendency test from the user terminal 2. And, the user tendency determiner 10 can determine the user tendency based on the received responses. The user terminal 2 can receive a signal received from the outside through the network. The signal received by the user terminal 2 can be processed as information by an application processor (AP). The AP can transfer the corresponding information to an application corresponding thereto. The corresponding application can make a decision based on the information received from the AP and display a result of making the decision on the user terminal 2, and/or transmit the result to the outside through the user terminal 2. For example, the application according to an embodiment can operate to make a decision based on the information received from the vehicle recommendation system 1 through the user terminal 2, display the decision result on the user terminal 2, process the information based on an input from the user terminal 2, and transmit the information to the vehicle recommendation system 1 through the user terminal 2.

The user question which can include a direct question related to purchasing a vehicle, which can include a question for obtaining information used for reducing a vehicle category. The user tendency test can be a question for identifying a user tendency. For example, the user question can include questions about a vehicle purchase budget of the user, the number of passengers to ride in a vehicle, a user's age, the use of the vehicle, the mileage of the vehicle per unit period, etc.

The user tendency can be determined by a plurality of user tendency elements. The plurality of user tendency elements can include economic feasibility indicating a degree of customer interest in a vehicle price, safety indicating a degree of customer interest in the defense function of the vehicle against external hazards or accidents, self-consciousness indicating a degree of customer interest in the evaluation of the customer by other people, technicality indicating a degree of customer interest in a new technology applied to the vehicle, reliability indicating a degree of customer interest in the quality assessment of the vehicle, functionality indicating a degree of customer interest in the performance of the vehicle, and aesthetics indicating a degree of customer interest in the design of the vehicle. However, a plurality of user tendencies is not necessarily limited to those listed above. That is, various elements that can be considered in determining the user tendency can be further considered in determining the user tendency. The user tendency test can be not a question directly asking the user tendency, but can be a question about a value judgment of the customer indirectly related to the user tendency.

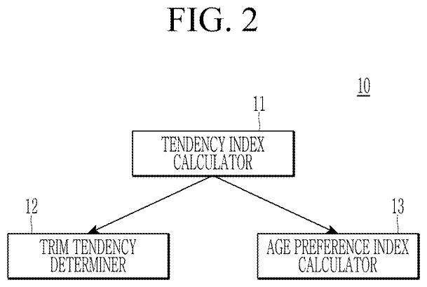

As shown in FIG. 2, in an embodiment, the user tendency determiner 10 can include a tendency index calculator ii that calculates a plurality of indexes for the plurality of user tendency elements based on the response to the user tendency test. The user tendency determiner 10 can determine the user tendency based on the calculated plurality of indexes.

Table 1 below shows a correlation between the user tendency test and the user tendency.

In Table 1, “A” which is a question for testing the user tendency can ask for a reaction of the customer in the corresponding condition, “B1” can be a response that is not related to the user tendency among user responses, “B2” can be a response related to the user tendency among customer responses, “Ca” can be an index indicating a degree of relevance to economic feasibility, “Cb” can be an index indicating a degree of relevance to safety, “Cc” can be an index indicating a degree of relevance to self-consciousness, “Cd” can be an index indicating a degree of relevance to technicality, “Ce” can be an index indicating a degree of relevance to reliability, “Cf” can be an index indicating a degree of relevance to functionality, and “Cg” can be an index indicating a degree of relevance to aesthetics.

TABLE 1

| A | B1 | B2 | Ca | Cb | Cc | Cd | Ce | Cf | Cg |
|---|---|---|---|---|---|---|---|---|---|
| If you see other | don't think | envy | | | | | | | |
| people's good | much | | | | | | | | |
| things | | | | | | | | | |
| If you hear other | empathize | advise | | | | | | | |
| people's concerns | | | | | | | | | |
| If a new cell | use current | want to | | | | | | | |
| phone is | cell phone | buy | | | | | | | |
| released | | | | | | | | | |
| If you are | pass over | demand | | | | | | | |
| harmed | | compen- | | | | | | | |
| by others | | sation | | | | | | | |
| | | for | | | | | | | |
| | | material/ | | | | | | | |
| | | mental | | | | | | | |
| | | damage | | | | | | | |
| If you see people | can pass | angry | | | | | | | |
| who make | over | | | | | | | | |
| small mistakes | | | | | | | | | |
| repeatedly | | | | | | | | | |
| If there is a | don't care | must see | | | | | | | |
| notification | | | | | | | | | |
| popping | | | | | | | | | |
| up in the app | | | | | | | | | |
| Our society | values | doesn't | | | | | | | |
| | safety | value | | | | | | | |
| | | safety | | | | | | | |
| Ordinary life is | good | boring | | | | | | | |
| If you can't buy | keep | give up | | | | | | | |
| what you want | thinking | easily | | | | | | | |
| Solving complex | dislike | like | | | | | 1 | | |
| problems | | | | | | | | | |
| If you lose the | could be | want to | | | | | | | |
| game | | win | | | | | | | |
| In the escalator | standing | moving | | | | | | | |
| Impulse buying | stress | stupid | | | | | | | |
| | relieving | | | | | | | | |
| For an | late | arrive | | | | | | | |
| appointment | | at ease | | | | | | | |
| Food I've never | reluctant | try | | | | | | | |
| seen before | | | | | | | | | |
| Unplanned trip | exciting | uneasy | | | 1 | 1 | | | |
| If you have | feeling | happy | | | | | | | |
| to adapt to a new | stressed | | | | | | | | |
| environment | | | | | | | 1 | | |

Table 1 above is an example of the user tendency test, and other embodiments are not necessarily limited thereto. The tendency index calculator 11 can derive indexes for the plurality of user tendency elements by summing user tendency indexes corresponding to “B2” among user responses to a plurality of questions of the user tendency test. For example, among the questions in Table 1, when a response to the question “If you see other people's good things” is “envy”, 3 can be reflected to the index for self-consciousness. When responses to all the questions in Table 1 are “B2”, the indexes for the plurality of user tendency elements such as economic feasibility, safety, self-consciousness, technicality, reliability, functionality, and aesthetics can be respectively 14, 5, 5, 15, 11, 8, and 2.

Alternatively, the tendency index calculator 11 according to an embodiment can determine the user tendency by collecting quantified responses of the user tendency test for each user tendency element. The tendency index calculator 11 can sum results obtained by multiplying a quantified response to each of the plurality of questions constituting the user tendency test by a sensitivity for each of the plurality of user tendency elements of each question. The user tendency determiner 10 can determine the user tendency based on the summation results according to the plurality of user tendency elements.

Table 2 below is a table is an example showing summation results for each of the plurality of user tendency elements based on the sensitivity of the plurality of user tendency elements for each question and the user response. The sensitivity of the user tendency element can be a value representing an index of the corresponding tendency element.

As shown in Table 2, the indexes for the plurality of user tendency elements are 15, 20, 19, 4, 11, 28, and 11, and the user tendency can be determined to have a pattern of technicality>safety>self-consciousness.

TABLE 2

| | | eco- | | self- | | | | |
|---|---|---|---|---|---|---|---|---|
| | user | nomic | | con- | tech- | | func- | |
| | re- | feasi- | | scious- | nical- | relia- | tion- | esthet- |
| | sponse | bility | safety | ness | ity | bility | ality | ics |
| question1 | 2 | 5 | 0 | 1 | 1 | 0 | 0 | 0 |
| question | 1 | 0 | 5 | 0 | 0 | 0 | 0 | 1 |
| 2 | | | | | | | | |
| question | 3 | 1 | 2 | 5 | 0 | 0 | 1 | 0 |
| 3 | | | | | | | | |
| question | 5 | 0 | 1 | 0 | 0 | 0 | 5 | 1 |
| 4 | | | | | | | | |
| question | 0 | 1 | 0 | 0 | 5 | 1 | 0 | 1 |
| 5 | | | | | | | | |
| question | 2 | 1 | 2 | 0 | 1 | 5 | 0 | 0 |
| 6 | | | | | | | | |
| question | 1 | 0 | 0 | 2 | 0 | 1 | 0 | 5 |
| 7 | | | | | | | | |

| | | | | | | | |
|---|---|---|---|---|---|---|---|
| result | 15 | 20 | 19 | 4 | 11 | 28 | 11 |

FIG. 2 is an example diagram illustrating a configuration of a user tendency determiner.

As shown in FIG. 2, the user tendency determiner 10 can further include a trim tendency determiner 12 that determines a trim tendency corresponding to the user based on the user tendency.

With respect to a plurality of vehicle models, a plurality of trims for each vehicle model can be determined by grouping specifications (hereinafter, option specifications) excluding a specification (e.g., power train) that is a reference for selection of a vehicle model from among a plurality of specifications of each vehicle model. Power trains can include gasoline, diesel, gasoline turbo, hybrid, plug-in hybrid, and electric vehicles, for example. Option specifications can include a specification related to driving safety, a specification related to exterior and interior of the vehicle, seats of the vehicle, a convenience specification for improving driving convenience, use related to infotainment, etc. The “plurality of vehicle models” can mean all vehicle models that can be recommended by the vehicle recommendation system 1 to the user.

Option specifications constituting the trim tendency can be determined based on option specifications selected by the user to satisfy a certain requirement when purchasing a vehicle based on results of a survey conducted on a large number of users or existing accumulated data. For example, the user's requirements when purchasing the vehicle can include cost-effectiveness, safety, dress-up, new technology, or any combination thereof. Accordingly, a plurality of trim tendencies can include cost-effectiveness, safety, dress-up, and new technology. The trim of each trim tendency can be configured with option specifications selected to meet the user's requirements such as cost-effectiveness, safety, dress-up, and new technology. For example, a first trim having cost-effectiveness as the trim tendency can include only basic option specifications such as artificial leather seats, a smart key, a phone projection (Android Auto, Car Play), and a heated driver's seat, a second trim having safety as the trim tendency can further include safety-related option specifications such as forward collision avoidance assist, smart cruise control, blind spot collision avoidance assist, rear cross traffic collision avoidance assist, and navigation in addition to the first trim, a third trim having dress-up as the trim tendency can further include option specifications related to appearance such as a high-resolution color TFT LCD, a smart power tailgate, a 220V inverter, a C-pillar color garnish, and a sunroof in addition to the first trim, and a fourth trim having a new technology as the trim tendency can further include option specifications related to high-tech such as a digital key, a built-in cam, an auxiliary battery, a high-resolution color TFT LCD, a smart power tailgate, a 220V inverter, a driving position memory system, and a reverse interlocking auto-downside outside mirror in addition to the first trim. The above examples of option specifications included in the trim of each trim tendency can be changed according to recent trends, recent technologies, etc., and embodiment of the present disclosure is not necessarily limited thereto.

The trim tendency determiner 12 can set indexes of a plurality of user tendency elements respectively for the plurality of trim tendencies. The indexes of the plurality of user tendency elements for the respective trim tendencies can be set through a survey conducted on users. When data of the user tendency according to each of the plurality of trim tendencies is accumulated while providing an optimal vehicle recommendation service, the trim tendency determiner 12 can use the accumulated data to determine the indexes of the plurality of user tendency elements respectively for the plurality of trim tendencies.

Table 3 is an example table showing indexes of the plurality of user tendency elements respectively for the plurality of trim tendencies according to an embodiment. Hereinafter, each of the indexes of the plurality of user tendency elements respectively for the plurality of trim tendencies is referred to as a reference index.

TABLE 3

| classification | cost-effectiveness | safety | dress-up | new technology |
|---|---|---|---|---|
| economic feasi- | 5 | 2 | 1 | 1 |
| bility | | | | |
| safety | 2 | 5 | 2 | 3 |
| self- | 1 | 1 | 5 | 3 |
| consciousness | | | | |
| technicality | 1 | 3 | 4 | 5 |
| reliability | 3 | 4 | 2 | 3 |
| functionality | 2 | 0 | 1 | 5 |
| esthetics | 1 | 1 | 4 | 1 |

The trim tendency determiner 12 can calculate a standard deviation between indexes according to the plurality of user tendency elements received from the tendency index calculator 11 and a corresponding reference index of each of the plurality of trim tendencies, and determine a trim tendency having the smallest standard deviation among the plurality of trim tendencies as a trim tendency of the user.

For example, Table 4 below is an example table showing weights according to the plurality of user tendency elements of a certain user.

TABLE 4

| | | self- | tech- | | | |
|---|---|---|---|---|---|---|
| economic | | conscious- | nical- | relia- | function- | |
| feasibility | safety | ness | ity | bility | ality | esthetics |
| 2 | 3 | 4 | 5 | 1 | 0 | 1 |

The trim tendency determiner 12 can square differences −3, 1, 3, 4, −2, −2, and 0 between a reference weight (for example, a trim tendency “cost-effectiveness”: 5, 2, 1, 1, 3, 2, and 1) for each of the economic feasibility, safety, self-consciousness, technicality, reliability, functionality, and aesthetics of each trim tendency and the weights 2, 3, 4, 5, 1, 0, and 1 according to the plurality of user tendency elements, calculate an average 43/7 of sum of squared results 9, 1, 9, 16, 4, 4, and 0, process the square root (approximately 2.5) of the calculated average 43/7, and calculate the standard deviation. The trim tendency determiner 12 can summarize the standard deviation of the user tendency for each of the plurality of trim tendencies as shown in Table 5 below, for example.

TABLE 5

| | | | | new |
|---|---|---|---|---|
| | cost-effectiveness | safety | dress-up | technology |
| standard | 2.5 | 1.9 | 1.5 | 1.8 |
| deviation | | | | |

The trim tendency determiner 12 can determine dress-up having the smallest standard deviation of 1.5 among a plurality of standard deviations as the trim tendency of the user.

Alternatively, when a difference between the smallest standard deviation (first order standard deviation) and a second smallest standard deviation (second order standard deviation) among the plurality of standard deviations is less than or equal to a predetermined deviation reference value, the trim tendency determiner 12 can determine two trim tendencies having the first and second order standard deviations as trim tendencies conforming to the user tendency. In this regard, the trim tendency determiner 12 can determine a value obtained by multiplying a maximum difference between the plurality of standard deviations by a predetermined first ratio as a predetermined deviation reference value. For example, in Table 5, the maximum difference between the plurality of standard deviations is 1 (=2.5−1.5), and when the predetermined first ratio is 0.2, the deviation reference value is 0.2. Since the difference between the first order standard deviation and the second order standard deviation is 0.3, the trim tendency having the second order standard deviation does not correspond to the trim tendency of the user. If the standard deviation for the trim tendency “new technology” is 1.7, the difference between the first order standard deviation and the second order standard deviation becomes less than or equal to the deviation standard value, and the trim tendency determiner 12 can determine the trim tendencies “dress-up” and “new technology” as the trim tendencies of the user.

Alternatively, the trim tendency determiner 12 can select a trim tendency having the smallest standard deviation (first order standard deviation) and all standard deviations falling within a predetermined deviation range with respect to the first order standard deviation from among the plurality of standard deviations as the trim tendency conforming the user tendency. In this case, the trim tendency determiner 12 can determine a value obtained by multiplying a maximum difference between the plurality of standard deviations by a predetermined second ratio as a predetermined deviation range. For example, in Table 5, when the maximum difference between the plurality of standard deviations is 1 (=2.5−1.5), and the predetermined ratio is 0.3, the deviation reference value is 0.3. A trim tendency having a standard deviation within 0.3 with respect to the first order standard deviation can correspond to an optimal vehicle. Since the standard deviation of the trim tendency “new technology” is 1.8, the standard deviation of “new technology” is within the predetermined deviation range with respect to the first order standard deviation. Accordingly, the trim tendency determiner 12 can determine the trim tendencies “dress-up” and “new technology” as the trim tendencies of the user.

As shown in FIG. 1, the vehicle recommendation system 1 can further include the vehicle tendency index calculator 20, the vehicle trim tendency determiner 30, and the price index calculator 40.

The vehicle tendency index calculator 20 can calculate a plurality of indexes for the plurality of vehicle tendency elements based on data (hereinafter, vehicle data) and evaluation data (hereinafter, vehicle evaluation data) for each vehicle with respect to each of a plurality of vehicles. A “plurality of vehicles” can be classified according to vehicle models, and vehicle models can be classified according to vehicle names and powertrains, for example. For example, when the vehicle name is “AVANTE” and the powertrain of “AVANTE” is 6, such as gasoline, diesel, gasoline turbo, hybrid, plug-in hybrid, and electric vehicle, the vehicle model is 6. The vehicle recommendation system 1 according to an embodiment includes the vehicle tendency index calculator 20, but the vehicle tendency index calculator 20 can be configured as a separate device outside the vehicle recommendation system 1, and can transmit a plurality of index information of the plurality of vehicle tendency elements for a requested vehicle in response to a request from the vehicle recommendation system 1 through a network. Alternatively, the vehicle recommendation system 1 can construct and include the plurality of index information of the plurality of vehicle tendency elements for each of the plurality of vehicles as a database.

The vehicle data can include data related to specifications, price, color, performance, and maintenance cost of the vehicle. The vehicle evaluation data can include evaluation data for each vehicle provided by a vehicle evaluation agency and evaluation data collected from users by the vehicle recommendation system 1. A plurality of vehicle data and vehicle evaluation data can be stored in the database of the vehicle recommendation system 1. The vehicle recommendation system 1 can accumulate the plurality of vehicle data and the plurality of vehicle evaluation data, classify the accumulated data according to vehicles, and store the classified data in the database. The vehicle recommendation system 1 can collect information about vehicle data provided by a vehicle manufacturer, classify the collected information according to vehicles, and store the classified information in the database. The vehicle recommendation system 1 can request and collect vehicle evaluation data from a server of an evaluation agency, classify the collected data according to vehicles, and store the classified data in the database.

The vehicle tendency index calculator 20 can calculate the indexes for the plurality of vehicle tendency elements based on the vehicle data and the vehicle evaluation data. The plurality of vehicle tendency elements can be elements corresponding to the plurality of user tendency elements, and in an embodiment, the plurality of vehicle tendency elements and the plurality of user tendency elements are described to be the same. However, an embodiment is not necessarily limited thereto, and the plurality of vehicle tendency elements and the plurality of user tendency elements can have the corresponding relationship but are preferably not the same.

The vehicle tendency index calculator 20 can determine an index for economic feasibility, which can include one of the vehicle tendency elements, based on the price of the vehicle and the maintenance cost for a predetermined period of the vehicle data. The maintenance cost can include fuel cost and insurance premium.

The vehicle tendency index calculator 20 can determine an index for safety, which can include one of the vehicle tendency elements, based on certified data in the vehicle evaluation data and data related to safety in the vehicle data. Certified data related to safety can be collected from Insurance Institute for Highway Safety (IIHS) in USA, Korean New Car Assessment Program (KNCAP) in Korea, European New Car Assessment Programme (EuroNCAP) in Europe, Ministry of Land, Infrastructure, and Transport, Ministry of Environment, Ministry of Industry, Insurance Development Institute, etc., for example.

The vehicle tendency index calculator 20 can determine an index for self-consciousness, which can include one of the vehicle tendency elements, by using the vehicle evaluation data. Certified data related to self-consciousness can be collected from consumer report (CR) in USA, AutoBilt in Europe, MotorTrend in USA, etc., or can be collected from survey results regarding brand values of vehicle manufacturers.

The vehicle tendency index calculator 20 can determine an index for technicality, which can include one of the vehicle tendency elements, based on a new technology newly applied to the vehicle in the vehicle data. For example, the index for technicality can be high for a vehicle to which autonomous driving, hydrogen car, electric car, and a new anti-collision system, etc. can be applied.

The vehicle tendency index calculator 20 can determine an index for reliability, which can include one of the vehicle tendency elements, based on the vehicle evaluation data. Certified data related to reliability can include JD Power's (USA) new car quality index, internal quality index, etc.

The vehicle tendency index calculator 20 can determine an index for functionality, which can include one of vehicle tendency elements, based on the vehicle data. Vehicle data related to functionality can include vehicle weight, performance of a vehicle engine, performance of a vehicle motor, etc.

The vehicle tendency index calculator 20 can determine an index for aesthetics, which can include one of the vehicle tendency elements, based on the vehicle evaluation data. Certified data related to aesthetics can be collected from International Forum (IF) in Europe, International Design Excellence Award (IDEA) in USA, etc.

The above description is an example according to an embodiment, and an embodiment is not necessarily limited thereto. The vehicle tendency index calculator 20 can use the vehicle data and/or the vehicle evaluation data when determining the vehicle tendency element, and is not necessarily limited to the example described above. For example, an index for a vehicle tendency element can be determined using data accumulated by the vehicle recommendation system 1 together with or instead of certified data.

The vehicle trim tendency determiner 30 can determine a trim tendency of each vehicle based on option specifications provided in each of the plurality of vehicles. As described above, the trim tendency can include cost-effectiveness, stability, dress-up, and new technology, and the vehicle trim tendency determiner 30 can determine the trim tendency of each vehicle as cost-effectiveness, stability, dress-up, new technology, and combinations thereof, according to option specifications provided in each vehicle.

The price index calculator 40 can derive a price index based on the price of each vehicle and the vehicle purchasing budget of the user with respect to the plurality of vehicles. For example, the price index can be an index indicating a degree of matching between the vehicle purchase budget of the user and the vehicle price.

The price index calculator 40 can determine the price index using a standard deviation method, a proportional calculation method, a clustering method, or any combination thereof.

When following the standard deviation method, the price index calculator 40 can derive a vehicle price range to which a predetermined standard deviation can be applied to the vehicle purchase budget (or budget range) received from the user terminal 2, and when the vehicle price belongs to the derived vehicle price range, derive the price index for the corresponding vehicle price using a price index function.

For example, the price index calculator 40 can derive the vehicle price range having a standard deviation of a predetermined ratio based on the vehicle purchase budget. The predetermined ratio can be a value that can vary depending on the design, and can be set according to a result of investigating an acceptable budget range based on the vehicle price when a vehicle is purchased through a survey or accumulated big data. The price index calculator 40 can calculate a standard deviation σ by multiplying a vehicle purchase budget μ by the predetermined ratio, and set the vehicle price range having a value μ−σ obtained by subtracting the standard deviation σ from the vehicle purchase budget μ as a lower limit and a value μ+σ obtained by adding the standard deviation σ to the vehicle purchase budget μ as an upper limit. The price index calculator 40 can derive the price index as 0 when the price of the vehicle is beyond the vehicle price range. Then, when a difference between the vehicle purchase budget of the user and the vehicle price is large, the corresponding vehicle can be excluded from a selection target of the user. The price index calculator 40 can derive the price index using a probability density function. Equation 1 shown below can be a price index function equation. The price index function can be set such that the price index is 1 when the vehicle price is equal to the vehicle purchase budget.

### [Equation 1]

$$f ( x ) = {e}^{- \frac{{( x - μ )}^{2}}{2 {σ}^{2}}}$$

In Equation 1, x denotes the price of the vehicle, μ denotes the vehicle purchase budget, σ denotes the standard deviation, and f(x) denotes the price index function, which can include the price index.

As a specific example for better understanding, when the vehicle purchase budget μ is 30 million KRW, and the predetermined ratio is 17%, the standard deviation σ is 5.1 million KRW, the lower limit μ−σ of the vehicle price range is 24.9 million KRW, and the upper limit μ+σ of the vehicle price range is 35.1 million KRW. When the price of the vehicle is less than 24.9 million KRW or exceeds 35.1 million KRW, the price index can be derived as 0. When the price of the vehicle is 27 million KRW, the price index is 0.841.

Alternatively, when receiving a vehicle purchase budget range from the user terminal 2, the price index calculator 40 can set the vehicle purchase budget range as the vehicle price range without setting the vehicle price range. The price index calculator 40 can set the vehicle purchase budget based on the vehicle purchase budget range, and derive the standard deviation according to a difference between the vehicle purchase budget range and the vehicle purchase budget. The price index calculator 40 can derive the price index by substituting the standard deviation, the vehicle purchase budget, and the price of the vehicle into the price index function of Equation 1. The price index calculator 40 can set a representative value indicating the vehicle purchase budget range as the vehicle purchase budget. For example, the representative value can be a median value.

As a specific example for better understanding, when the vehicle purchase budget range is 27 million to 33 million KRW, the vehicle purchase budget μ is 30 million KRW, and the standard deviation σ is 3 million KRW that is a difference between the minimum value and the maximum value of the vehicle purchase budget range and the vehicle purchase budget. Since the vehicle price range is the same as the vehicle purchase budget range, the lower limit μ−σ of the vehicle price range is 27 million KRW, and the upper limit μ+σ of the vehicle price range is 33 million KRW. When the price of the vehicle is less than 27 million KRW or exceeds 33 million KRW, the price index can be derived as 0. When the price of the vehicle is 28.5 million KRW, the price index is 0.882.

The price index calculator 40 according to an embodiment can determine the price index according to the proportional calculation method. When following the proportional calculation method, the price index calculator 40 can derive a vehicle price range having a predetermined margin with respect to the vehicle purchase budget (or budget range) received from the user terminal 2, and when the vehicle price belongs to a proportional range of the vehicle price range, derive a price index proportional to the price of a vehicle.

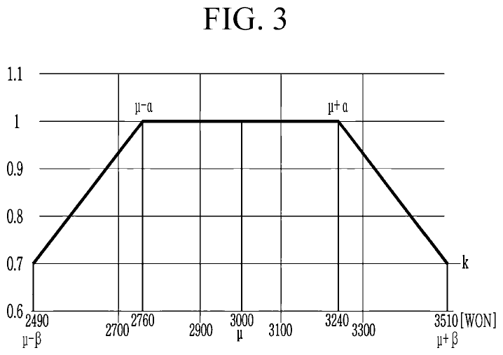

FIG. 3 is a graph for explaining a method, performed by a price index calculator, of determining a price index through proportional calculation according to an embodiment.

In the graph shown in FIG. 3, the x-axis indicates a vehicle price range, and the y-axis indicates a price index. As shown in FIG. 3, the price index calculator 40 can set the vehicle price range by setting a value obtained by subtracting a predetermined margin β from the vehicle purchase budget μ as a lower limit μ−β and a value obtained by adding the predetermined margin β to the vehicle purchase budget μ as an upper limit μ+β. The price index calculator 40 can calculate the predetermined margin β by multiplying the vehicle purchase budget μ by a predetermined ratio. The predetermined ratio can be a value that can vary depending on the design, and can be set according to a result of investigating an acceptable budget range based on the vehicle price when a vehicle is purchased through a survey or accumulated big data.

As shown in FIG. 3, the price index calculator 40 can set a range (hereinafter, a price index fixed range) in which the price index is 1 in the vehicle price range. The price index calculator 40 can set a budget factor fixed range by setting a value obtained by subtracting a predetermined reference value a from the vehicle purchase budget μ as a lower limit μ−α and a value obtained by adding the predetermined reference value α to the vehicle purchase budget μ as an upper limit μ+α. The price index calculator 40 can calculate the predetermined reference value a by multiplying the vehicle purchase budget μ by a predetermined reference ratio. The predetermined reference ratio is a value that can vary depending on the design, and was set at 8% in an embodiment. Considering that the acquisition tax is 7% and the public bond is around 10% of the acquisition tax when purchasing a vehicle, the budget factor fixed range which can include a range where the budget does not affect the purchase of a vehicle, can be set. The price index calculator 40 can set the lowest value of the budget factor. In an embodiment, the lowest value of the budget factor can be 0.7. The price index calculator 40 can determine a price index for a vehicle as 0 when the vehicle price is less than the lower limit or exceeds the upper limit of the vehicle price range.

In a specific example for better understanding, when the vehicle purchase budget is 30 million KRW, the predetermined reference value α is 2.4 million KRW, the predetermined margin β is 5.1 million KRW, and k is 0.7. Then, as shown in FIG. 3, the vehicle price range is 24.9 million KRW to 35.1 million KRW, and the price index fixed range is 27.6 million KRW to 32.4 million KRW. In proportional ranges of 24.9 million KRW to 27.6 million KRW and 32.40 million KRW to 35.1 million KRW in which the price index is proportional to the vehicle price, the price index calculator 40 can use price index functions as shown in Equations 2 and 3 below to derive the price index for the vehicle. In Equations 2 and 3 (shown below), x can be the price of the vehicle:

f(x)=k+(1−k)*(minimum value of x-vehicle price range)/α,(minimum value of vehicle price range≤x<minimum value of budget factor fixed range) [Equation 2]

f(x)=k+(1−k)*(maximum value-x of vehicle price range)/α,(maximum value of budget factor fixed range<x≤maximum value of vehicle price range). [Equation 3]

Alternatively, when receiving the vehicle purchase budget range from the user terminal 2, the price index calculator 40 can set the vehicle purchase budget range as the vehicle price range, determine the price index to be 1 for a vehicle belonging to the vehicle price range, and determine the price index to be 0 for a vehicle beyond the vehicle price range.

As a specific example for better understanding, when the vehicle purchase budget range is 27 million KRW to 33 million KRW, the vehicle price range can be the same as the vehicle purchase budget range. When the price of the vehicle falls within the range of 27 million KRW to 33 million KRW, the price index for the vehicle can be derived as 1, and when the price of the vehicle is less than 27 million KRW or exceeds 33 million KRW, the price index for the vehicle can be derived as 0.

The price index calculator 40 according to an embodiment can determine the price index according to a clustering method. When following a clustering method, the price index calculator 40 can derive the vehicle price range having a predetermined margin with respect to the vehicle purchase budget (or budget range) received from the user terminal 2, divide the vehicle price range into a plurality of ranges, set a price index according to each range, and derive the price index of the range to which the vehicle price belongs among the plurality of ranges as the budget factor of the vehicle.

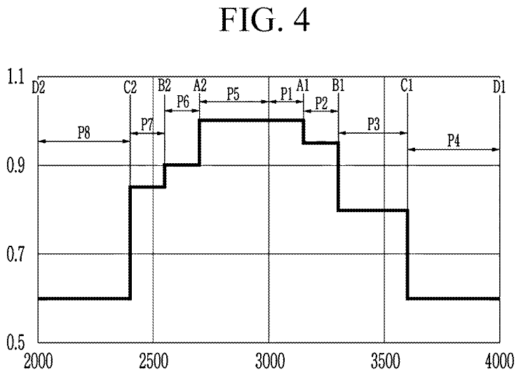

FIG. 4 is a graph for explaining a method, performed by a price index calculator, of determining a price index through clustering according to an embodiment.

As shown in FIG. 4, the price index calculator 40 can differently set a plurality of ranges for a case where the price of a vehicle is high and a case where the price of the vehicle is low with respect to a vehicle purchase budget. In FIG. 4, vehicle purchase budget can be 30 million KRW, and a predetermined margin can be 10 million KRW.

For example, when the price of the vehicle is higher than the vehicle purchase budget, the price index calculator 40 can determine a boundary value A1 of a first period P1 as a value obtained by multiplying the vehicle purchase budget by a predetermined first ratio (e.g., 8%). The predetermined first ratio can be determined to be 8% considering that the acquisition tax is 7% and the public bond is around 10% of the acquisition tax when purchasing a vehicle. The price index calculator 40 can determine a boundary value B1 of a second period P2 by multiplying the vehicle purchase budget by a predetermined second ratio (e.g., 10%). The predetermined second ratio can be determined to be 10% by considering the insurance cost of the vehicle in addition to the predetermined first ratio. The price index calculator 40 can determine a boundary value C1 of a third period P3 by multiplying the vehicle purchase budget by a predetermined third ratio (e.g., 20%). The predetermined third ratio can be determined in consideration of an economic burden felt by a user. The price index calculator 40 can determine a boundary value D1 of a fourth period P4 by multiplying the vehicle purchase budget by a predetermined fourth ratio (e.g., 33.3%). The predetermined fourth ratio is an arbitrarily set margin ratio. The price index of the first period P1 can be 1, the price index of the second period P2 can be 0.95, the price index of the third period P3 can be 0.8, and the price index of the fourth period P4 can be 0.6, and the price index of the vehicle price range higher than the fourth period P4 can be 0.

Next, when the price of the vehicle is lower than the vehicle purchase budget, the price index calculator 40 can determine a boundary value A2 of a fifth period P5 by multiplying the vehicle purchase budget by a predetermined fifth ratio (e.g., 10%). The predetermined fifth ratio can be determined as 10% by adding the insurance cost of the vehicle to 8% considering that the acquisition tax is 7% and the public bond is about 10% of the acquisition tax when purchasing a vehicle. The price index calculator 40 can determine a boundary value B2 of a sixth section by multiplying the vehicle purchase budget by a predetermined sixth ratio (e.g., 15%). The predetermined sixth ratio can be determined with respect to a reference point at which the user satisfaction with a vehicle of a price lower than the vehicle purchase budget starts to decrease. The price index calculator 40 can determine a boundary value C2 of a seventh period P7 by multiplying the vehicle purchase budget by a predetermined seventh ratio (e.g., 20%). The predetermined seventh ratio can be determined with respect to a critical point at which the user satisfaction with the vehicle of the price lower than the vehicle purchase budget rapidly decreases. The price index calculator 40 can determine a boundary value D2 of an eighth period P8 by multiplying the vehicle purchase budget by a predetermined eighth ratio (e.g., 33.3%). The predetermined eighth ratio can be an arbitrarily set margin ratio. The price index of the fifth period P5 can be 1, the price index of the sixth period P6 can be 0.9, the price index of the seventh period P7 can be 0.85, the price index of the eighth period P8 can be 0.6, and, the price index of the vehicle price range lower than the eighth period P8 can be 0.

Price indexes of the first to eighth periods P1 to P8 can be different from the values described above. For example, the price index of the fifth period P5 can have the highest value of 1.1.

The price index calculator 40 can determine a smaller value of a value obtained by subtracting a predetermined value from the vehicle purchase budget and a value obtained by multiplying the vehicle purchase budget by a predetermined ratio as the boundary value D2 of the eighth period P8. The predetermined value and the predetermined ratio can be determined based on a survey or accumulated big data.

When receiving a vehicle purchase budget range from the user terminal 2, the price index calculator 40 according to an embodiment can set the vehicle purchase budget range as a vehicle price range, and determine the price index for a vehicle beyond the vehicle price range to be 0. In addition, the price index calculator 40 can determine the vehicle purchase budget by multiplying a median value of the received vehicle purchase budget range by a predetermined ratio. The price index calculator 40 can set a range from the minimum value of the vehicle purchase budget range to the vehicle purchase budget range as the fifth period P5 described above, and set a range from the vehicle purchase budget to the maximum value of the vehicle purchase budget range as the sixth period P6 described above.

The age index calculator 50 (shown in FIG. 1) can derive an age index for the age of users predicted to purchase each vehicle with respect to a plurality of vehicles. For example, the age index can indicate the age of users who prefer each vehicle.

The age index calculator 50 can determine the age index of a vehicle in consideration of the segment, brand, type, and energy source of the vehicle. The segment of the vehicle indicates the size of the vehicle, and the older the user, the larger the vehicle can be preferred. The age index calculator 50 can increase the age index of the vehicle as the segment of the vehicle increases. Preferred brands can differ according to the age of users. The age index calculator 50 can increase or decrease the age index according to brands of vehicle. For example, users who prefer BMW to BENZ can be younger, and the age index calculator 50 can reduce the age index when the brand of the vehicle is BMW, and increase the age index when the brand of the vehicle is BENZ. Types of vehicle can be classified into a SUV, a sedan, a hatchback, a coupe, etc., and users who prefer a specific type can be young. The age index calculator 50 can increase or decrease the age index according to types of vehicle. For example, users who prefer the coupe to the sedan can be younger than users who prefer the sedan. The age index calculator 50 can decrease the age index when the type of vehicle is the coupe. The energy source is the power of vehicle and can be classified into gasoline, diesel, electricity, hybrid, hydrogen, etc. The age index calculator 50 can increase or decrease the age index according to the energy source of the vehicle. For example, users who prefer electricity rather than gasoline and diesel can be younger than users who prefer gasoline and diesel. The age index calculator 50 can decrease the age index when the energy source of the vehicle is electricity.

A value corresponding to the age index of the vehicle can be an age preference index of the user. The age preference index of the user can indicate the user's preference for a method of classifying vehicles based on the age index. For a user having a higher age preference index, a degree to which the age index of the vehicle contributes to vehicle recommendation can increase.

As shown in FIG. 2, the user tendency determiner 10 can include an age preference index calculator 13 that calculates the age preference index of the user. In FIG. 2, the user tendency determiner 10 includes the age preference index calculator 13, but an embodiment is not necessarily limited thereto. The age preference index calculator 13 can be implemented as a component separated from the user tendency determiner 10.

The age preference index calculator 13 can calculate the age preference index based on indexes of a plurality of tendency elements of the user. The higher the indexes of the plurality of tendency elements, the stronger the expression of the user's preference can be regarded. Based on this, the age preference index calculator 13 can calculate the age preference index according to an average of indexes for the plurality of tendency elements of the user. For example, the age preference index calculator 13 can increase the age preference index as the average of indexes for the plurality of tendency elements increases.

The optimal tendency matcher 60 can derive a candidate vehicle from among the plurality of vehicles based on a trim tendency of the user and the price index. For example, the optimal tendency matcher 60 can derive a vehicle that meets the trim tendency of the user and has a price index greater than or equal to a predetermined critical price index among the plurality of vehicles as the candidate vehicle. The candidate vehicle refers to a vehicle to be determined by the vehicle recommendation system 1 whether it is suitable for recommendation to a user as a purchase vehicle. The optimal tendency matcher 60 can receive the trim tendency of the user from the user tendency determiner 10 and receive the trim tendency of each of the plurality of vehicles from the vehicle trim tendency determiner 30.

Additionally, the optimal tendency matcher 60 can determine the candidate vehicle by considering the estimated number of passengers together with the trim tendency of the user and the price index. The estimated number of passengers can be received from the user terminal 2, and the optimal tendency matcher 60 can determine a vehicle capable of carrying the actual number of passengers equal to or greater than the estimated number of passengers among the plurality of vehicles as the candidate vehicle. In general, when users drive a vehicle, the number of passengers who can actually ride in the vehicle can be determined as the actual number of passengers. The actual number of passengers can be different from the number of passengers according to vehicle specifications. For example, in the case of a Casper vehicle of Hyundai Motor, the number of passengers according to specifications is 4, but in the actual operation of Casper, the maximum number of passengers is generally 2. Then, the actual number of passengers of Casper is 2. Data of the actual number of passengers can be determined in advance through a survey of users, and the optimal tendency matcher 60 can store information about the actual number of passengers for the plurality of vehicles. Alternatively, the optimal tendency matcher 60 can decrease a tendency matching index at a constant rate when the actual number of passengers is smaller than the estimated number of passengers.

The optimal tendency matcher 60 can determine a vehicle that satisfies at least two of three conditions of being equal to the trim tendency of the user, having a price index greater than or equal to a critical price index, and being able to carry the actual number of passengers equal to or greater than the estimated number of passengers as the candidate vehicle.

The optimal tendency matcher 60 can respectively receive information about the user tendency and a vehicle tendency of each of a plurality of candidate vehicles from the user tendency determiner 10 and the vehicle tendency index calculator 20, determine a degree of matching between the user tendency and the vehicle tendency of each of the plurality of candidate vehicles, and generate a quantified tendency matching index. The information about the user tendency includes information about indexes of the plurality of user tendency elements, and the information about the vehicle tendency includes information about indexes of the plurality of vehicle tendency elements.

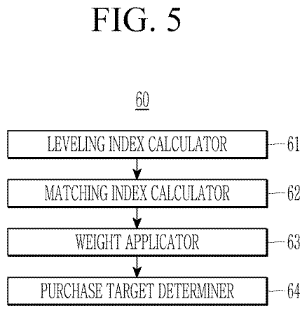

FIG. 5 is a diagram illustrating an optimal tendency matcher 60 according to an embodiment.

The optimal tendency matcher 60 can include a leveling index calculator 61, a matching index calculator 62, a weight applicator 63, and a purchase target determiner 64.

The leveling index calculator 61 can calculate a plurality of leveling indexes for leveling a plurality of indexes of a plurality of vehicle tendency elements of each candidate vehicle with respect to a plurality of candidate vehicles. Leveling is to adjust a level (average value, dispersion, etc.) of the index distributed according to vehicle tendency elements to a similar level. For example, an index distribution of safety, which can include one of a plurality of vehicle tendencies, can be less correlated with a vehicle price, but an index distribution of self-consciousness, which can include another one of the plurality of vehicle tendencies, can be highly correlated with the vehicle price. Because a candidate vehicle is determined based on the price index, the index distribution level of each of a plurality of vehicle tendency elements of each candidate vehicle varies according to the correlation with the vehicle price, and thus, leveling can be required.

The leveling index calculator 61 can calculate a leveling index for each of the plurality of vehicle tendency elements with respect to all of the plurality of candidate vehicles. For example, the leveling index calculator 61 can calculate a sum Si (i is a variable indicating one of economic feasibility, safety, self-consciousness, technicality, reliability, functionality, and aesthetics, and can be one of natural numbers from 1 to 7) of indexes of any one of the plurality of vehicle tendency elements with respect to all of the plurality of candidate vehicles, and calculate a leveling index for each vehicle tendency element by dividing a number N_CAR of the plurality of candidate vehicles by the sum Si of indexes of each vehicle tendency element. Specifically, when the number of the plurality of candidate vehicles is 100 and the sum of indexes of economic feasibility for the plurality of candidate vehicles is 400, the leveling index can be 0.25. As described above, the leveling index calculator 61 can calculate the leveling index for each of the plurality of vehicle tendency elements.

The optimal tendency matcher 60 can further include the matching index calculator 62 for calculating a tendency matching index, which can include a matching index between a result of applying a plurality of leveling indexes to a vehicle tendency of each candidate vehicle with respect to the plurality of candidate vehicles and the user tendency.

The matching index calculator 62 can receive a plurality of first indexes for the plurality of user tendency elements from the user tendency determiner 10, receive a plurality of second indexes for the plurality of vehicle tendency elements of any one of the plurality of candidate vehicles from the vehicle tendency index calculator 20, calculate a plurality of third indexes by multiplying each of the plurality of second indexes by the corresponding leveling index, and calculate a plurality of fourth indexes by multiplying corresponding two indexes among the plurality of first indexes and the plurality of third indexes. The plurality of first indexes and the plurality of third indexes correspond to economic feasibility, safety, self-consciousness, technicality, reliability, functionality, and aesthetics, and the matching index calculator 62 can calculate the fourth index for economic feasibility by multiplying the first index for economic feasibility and the third index for economic feasibility.

The weight applicator 63 can calculate a tendency matching index by applying at least one weight according to each candidate vehicle with respect to a plurality of candidate vehicles to the plurality of fourth indexes of each candidate vehicle. For example, the weight applicator 63 can apply a weight to the fourth index of the corresponding vehicle tendency element among the plurality of vehicle tendency elements of each candidate vehicle according to a trim tendency of each of the plurality of candidate vehicles.

With respect to a plurality of vehicle models, the weight applicator 63 can store information about the trim tendency of each of a plurality of trims of each vehicle model and weights for vehicle tendency elements (or user tendency elements) corresponding to each trim tendency.

The weight applicator 63 can apply a weight according to a trim tendency of each candidate vehicle to a fourth index of a corresponding vehicle tendency element among a plurality of fourth indexes of each candidate vehicle. For example, the weight applicator 63 can apply a weight of 10% to a safety index among the vehicle tendency elements when the trim tendency is safety, apply a weight of 5% to an aesthetic index among the vehicle tendency elements when the trim tendency is dress-up, and apply a weight of 5% to a new technology index among the vehicle tendency elements when the trim tendency is new technology.

The weight applicator 63 can calculate a total index by summing the plurality of fourth indexes of each of the plurality of candidate vehicles in which the trim tendency is considered.

The weight applicator 63 can apply a camping factor index and a passenger factor index to the total index of each of the plurality of candidate vehicles, in addition to the weight according to the trim tendency. The camping factor index can be an index set when the candidate vehicle is a vehicle suitable for camping, and the passenger factor index can be an index set according to the number of passengers ridable in the candidate vehicle. The weight applicator 63 can calculate the tendency matching index by adding the camping factor index and the passenger factor index to the total index.

The purchase target determiner 64 can receive the tendency matching indexes for each of the plurality of candidate vehicles from the weight applicator 63, store a plurality of tendency matching indexes for all of the plurality of candidate vehicles, derive top j candidate vehicles corresponding to top j tendency matching indexes from the stored plurality of tendency matching indexes, and determine the derived top j candidate vehicles to be “purchase target vehicles”. The purchase target determiner 64 can list information about the purchase target vehicles and transmit the information to the user terminal 2. The information about the purchase target vehicles can include information about specifications of a user's vehicle, tendency matching index, etc.

The user can select one of the purchase target vehicles through the user terminal 2, and the user terminal 2 can transmit a selection input to the vehicle recommendation system 1. The vehicle recommendation system 1 can derive car masters suitable for the user from among a plurality of car masters selling the corresponding purchase target vehicle in response to a user input for selecting one of the purchase target vehicles, and provide the car masters to the user through the user terminal 2. The car master can be a vehicle sales dealer who has joined the vehicle recommendation system 1, and can provide information about vehicles available for sale to the vehicle recommendation system 1 through a car master terminal.

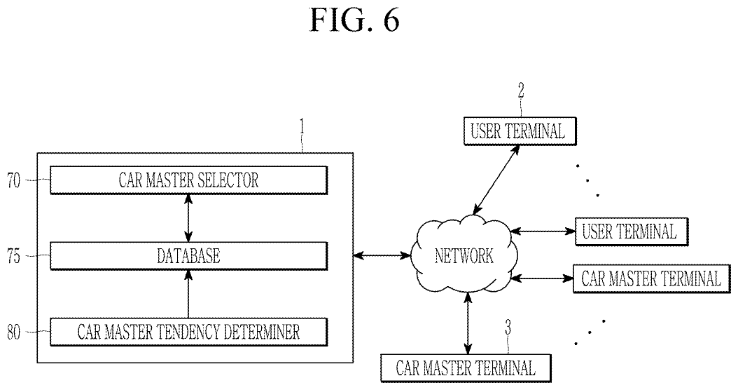

FIG. 6 is a diagram illustrating a part of a vehicle recommendation system according to an embodiment.

The vehicle recommendation system 1 can include components of the vehicle recommendation system shown in FIG. 6 together with components of the vehicle recommendation system shown in FIG. 1. The vehicle recommendation system 1 can be connected to a plurality of car master terminals 3 as well as a plurality of user terminals 2 through a network, and can transmit/receive information necessary for purchasing a vehicle.

The car master terminal 3 can receive a signal received from the outside through a network. The signal received by the car master terminal 3 can be processed as information by an application processor (AP). The AP can transfer the information to the corresponding application. The corresponding application can make a decision based on the information received from the AP, and display a result of the decision on the car master terminal 3, and/or transmit the result to the outside through the car master terminal 3. For example, the application according to an embodiment can operate to make a decision according to the information received from the vehicle recommendation system 1 through the car master terminal 3, display the decision result on the car master terminal 3, process information based on an input from the car master terminal 3, and transmit the information to the vehicle recommendation system 1 through the car master terminal 3. The car master can update introduction information to introduce a car master such as a car master's name, career, location, etc., vehicles currently available for sale, information about a car master's tendency, etc., to the vehicle recommendation system 1 through the car master terminal 3. The vehicle recommendation system 1 can store information about vehicles classified according to car masters and updated in a database 75.

As shown in FIG. 6, the vehicle recommendation system 1 can include a car master selector 70, a database 75, and a car master tendency determiner 80.

The car master selector 70 can receive information about a purchase target vehicle selected by the user terminal 2 from the vehicle recommendation system 1. The database 75 can classify and store information about a plurality of car masters and vehicles currently available for sale of each of the plurality of car masters. The database 75 can store introduction information and tendency information of each of the plurality of car masters according to car masters.

The car master selector 70 can identify a car master (hereinafter, candidate car master) selling the purchase target vehicle received from the database 75. The car master selector 70 can read introduction information about the candidate car master and information about a car master tendency from the database 75.

The car master tendency determiner 80 can determine the tendency of the car master in the same manner as the method of determining the user tendency described above, and store the information about the car master tendency in the database 75. The database 75 can match and store car master tendencies according to car masters.

The car master tendency determiner 80 can transmit a car master tendency test for selecting a car master that meets the user tendency to the car master terminal 3. The car master tendency test can include the same questions as the user tendency test. The car master tendency determiner 80 can receive a response to the car master tendency test from the car master terminal 3 and determine the car master tendency based on the received response. A plurality of car master tendency elements included in the car master tendency can be the same as the plurality of user tendency elements described above.

The car master selector 70 can select a final car master from among a plurality of candidate car masters according to various car master selection methods, and transmit information on the final car master selected according to the selected car master selection method to the user terminal 2. Alternatively, the car master selector 70 can select a final car master from among a plurality of candidate car masters according to a car master selection method selected by the user from among various car master selection methods, and transmit the final car master selected by the user terminal 2. A final car master can include at least one car master. Various car master selection methods can include, for example, a method of selecting a car master conforming a user tendency (hereinafter, a tendency matching method), a method of selecting a car master located within a certain distance with respect to a user location (hereinafter, a distance reference method), a method of selecting a car master of which evaluation score based on a customer evaluation is equal to or greater than a predetermined reference score (a customer evaluation reference method), etc.

First, a method, performed by the car master selector 70, of selecting the final car master according to a tendency matching method is described according to an embodiment.

Table 6 is an example table showing indexes of a plurality of tendency elements for four candidate car masters. Table 7 is an example table showing indexes of a plurality of tendency elements of a user.

TABLE 6

| | | | self- | tech- | | | |
|---|---|---|---|---|---|---|---|
| classifi- | economic | | conscious- | nical- | relia- | functional- | esthet- |
| cation | feasibility | safety | ness | ity | bility | ity | ics |
| car | 5 | 2 | 1 | 1 | 3 | 2 | 1 |
| master1 | | | | | | | |
| car | 2 | 5 | 1 | 3 | 4 | 0 | 1 |
| master2 | | | | | | | |
| car | 1 | 2 | 5 | 4 | 2 | 1 | 4 |
| master3 | | | | | | | |
| car | 1 | 3 | 3 | 5 | 3 | 4 | 1 |
| master4 | | | | | | | |

TABLE 7

| | | | self- | tech- | | | |
|---|---|---|---|---|---|---|---|
| classifi- | economic | | conscious- | nical- | relia- | function- | esthet- |
| cation | feasibility | safety | ness | ity | bility | ality | ics |
| user | 2 | 3 | 4 | 5 | 1 | 0 | 1 |

The car master selector 70 can calculate a standard deviation of differences between the plurality of tendency elements of each candidate car master and the plurality of tendency elements of the user with respect to a plurality of candidate car masters (car master 1 to car master 4). Table 8 is an example table showing a standard deviation of the differences between each of the plurality of candidate car masters (car master 1 to car master 4) and the plurality of tendency elements of the user calculated by the car master selector 70.

TABLE 8

| classification | car master 1 | car master 2 | car master 3 | car master 4 |
|---|---|---|---|---|
| standard | 2.5 | 1.9 | 1.5 | 1.8 |
| deviation | | | | |

The car master selector 70 can select the car master 3 having the smallest standard deviation of 1.5 as the final car master. The car master selector 70 can transmit introduction information about the car master 3 to the user terminal 2.

The car master selector 70 can select a candidate car master located within a predetermined reference distance from among the plurality of candidate car masters as the final car master with respect to the location of the user received from the user terminal 2 according to the distance reference method. At this time, the number of candidate car masters located within the reference distance can be plural.

The car master selector 70 can calculate an evaluation score based on customer evaluations of the plurality of candidate car masters, and select a candidate car master of which evaluation score is equal to or higher than a predetermined reference score as the final car master according to the customer evaluation reference method. In this case, the number of candidate car masters of which evaluation scores are equal to or higher than the reference score can be plural. The method of calculating the evaluation score based on the customer evaluation is not necessarily limited. When the customer evaluation is a numerical value, the car master selector 70 can calculate an average value of customer evaluation values for each candidate car master as an evaluation score. When the customer evaluation is not a numerical value, a quantification work on the customer evaluation can be preceded.

As mentioned above, the user terminal 2 can receive information about the purchase target vehicle from the vehicle recommendation system 1, and request information about a car master for the purchase target vehicle selected by the user input from the vehicle recommendation system 1.

The vehicle recommendation system 1 can determine a final car master among a plurality of candidate car masters for the purchase target vehicle and transmit the final car master to the user terminal 2. The vehicle recommendation system 1 can select a plurality of final car masters according to a plurality of car master selection methods. The user can select at least one of the plurality of final car masters through the user terminal 2 and receive a service for a vehicle purchase from the selected final car master. The service for the vehicle purchase can include a test drive service, a vehicle contract service, and a vehicle delivery service, for example. The test drive service can be a service of providing a vehicle selected by the user so that the user can drive the vehicle. The vehicle contract service can be a service of providing a purchase contract for the purchase target vehicle selected by the user. The vehicle delivery service can refer to a service of providing the user with the purchase target vehicle selected by the user.

The vehicle recommendation system 1 can charge from the final car master a corresponding fee for the test drive service, the vehicle contract service, the vehicle delivery service, or any combination thereof.

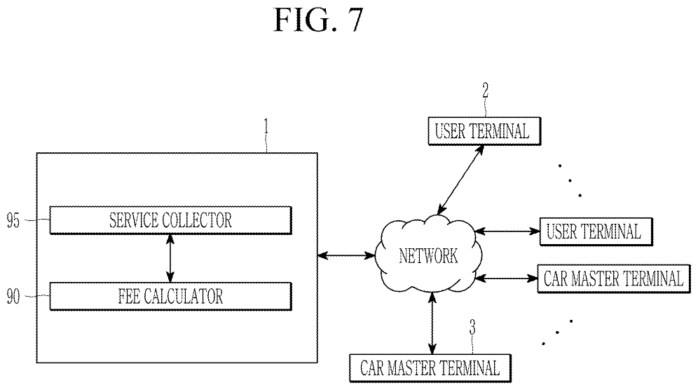

FIG. 7 is a diagram illustrating some configurations of a vehicle recommendation system according to an embodiment.

The vehicle recommendation system 1 can include components of the vehicle recommendation system shown in FIG. 7 together with components of the vehicle recommendation system shown in FIGS. 1 and/or 6.

The vehicle recommendation system 1 can include a fee calculator 90 and a service collector 95.

The service collector 95 can collect information about service provided to a user from a final car master from at least one of the car master terminal 3 of the final car master and the user terminal 2. For example, when the user receives a test drive service from the final car master, the user can transmit information notifying that the test drive service has been provided (service reception information) to the vehicle recommendation system 1 through the user terminal 2. Alternatively, when the final car master provides the test drive service to the user, the final car master can transmit information (service provision information) notifying that the test drive service has been provided to the vehicle recommendation system 1 through the car master terminal 3. Alternatively, both service receipt information and service provision information can be transmitted to the vehicle recommendation system 1. The service receipt information and the service provision information can be identified and collected by the service collector 95.

The service collector 95 can classify and store information about services provided by each car master with respect to a plurality of car masters in the database 75 based on the identified service reception information and service provision information. For example, the service collector 95 can match information about each of the test drive service, the vehicle contract service, and the vehicle delivery service provided by a certain car master among the plurality of car masters and store the information in a storage space of the database 75 for the corresponding car master.

The fee calculator 90 can calculate a fee for service provided to the user from the final car master. The fee can be a fee for service between the user and the final car master through the vehicle recommendation system 1, and can mean a monetary reward obtained by an entity operating the vehicle recommendation system 1. The fee calculator 90 can calculate a fee for services provided according to car masters collected by the service collector 95. The fee calculator 90 can request information necessary for fee calculation from the service collector 95. The service collector 95 can transfer service details provided by each car master to the fee calculator 90 as a response to the request.

The fee calculator 90 can calculate a fee for a service provided by each car master with respect to the plurality of car masters. The fee calculator 90 can calculate a fee for each car master based on a linkage ratio between two services that are linked among the test drive service, the vehicle contract service, and the vehicle delivery service. The fee calculator 90 can set the ratio between a test drive service fee and a vehicle contract service fee based on a first linkage ratio linked from a test drive to a vehicle contract, and set the ratio between the vehicle contract service fee and a vehicle delivery service fee based on a second linkage ratio from the vehicle contract to a vehicle delivery. For example, when the first connection ratio from the test drive to the vehicle contract is 20%, the fee calculator 90 can set the ratio between the test drive service fee and the vehicle contract service fee to 1:5 (=1/0.2). In addition, when the second linkage ratio from the vehicle contract to the delivery of the vehicle is 50%, the fee calculator 90 can set the ratio between the vehicle contract service fee and the vehicle contract service fee to 1:2 (=1/0.5).

In addition, the fee calculator 90 can set a fee charge unit for each service. For example, the fee calculator 90 can charge a fee for the test drive service per “person” and charge a fee for the vehicle contract service and the vehicle delivery service per “unit”.

Each of the plurality of car masters can select one service to pay a fee from among the test drive service, the vehicle contract service, and the vehicle delivery service through the car master terminal 3. Each car master can select one of the test drive service, the vehicle contract service, and the vehicle delivery service as a fee target service and transmit the selected service to the vehicle recommendation system 1 through the car master terminal 3. The fee calculator 90 can collect information about the fee target service together with identification information for identifying each car master and match and store the information about the fee target service in a storage space corresponding to each car master in the database 75.

Each of the plurality of car masters can set the first and second linkage ratios through the car master terminal 3. Unlike this, the vehicle recommendation system 1 can collect business data of each car master through the car master terminal 3 and calculate the first linkage ratio and the second linkage ratio based on the collected data. Accordingly, the first linkage ratio and the second linkage ratio can be set or calculated differently according to car masters.

The fee calculator 90 can set fees for the test drive service, the vehicle contract service, and the vehicle delivery service differently based on the first linkage ratio and the second linkage ratio of each of the plurality of car masters. For example, the fee calculator 90 can reduce the test drive service fee and the vehicle contract service fee at a first reduction ratio determined according to the first linkage ratio, and reduce the vehicle contract service fee and the vehicle delivery service fee at a second reduction ratio determined according to the second linkage ratio.

Specifically, as an example, the fee calculator 90 can calculate the test drive service fee, the vehicle contract service fee, and the vehicle delivery service fee according to Equations 4 to 6 below:

test drive service fee=(first basic fee)*(1−A1/B1) [Equation 4]

vehicle contract service fee=(second basic fee)*(1−A1/B1)*(1−A2/B2) [Equation 5]

vehicle delivery service fee=(third basic fee)*(1−A2/B2). [Equation 6]

In Equations 4 to 6, the first basic fee is a basic fee set as the test drive service fee, the second basic fee is a basic fee set as the vehicle contract service fee, and the third basic fee is a basic fee set as the vehicle delivery service fee. “A1” is the first linkage ratio, “A2” is the second linkage ratio, and “B1” and “B2” are predetermined coefficients greater than 1 and can be set to specific values according to a given design.

That is, as the first linkage ratio increases, the range of reduction of each of the test drive service fee and the vehicle contract service fee can increase, and as the second linkage ratio can increase, the range of reduction of each of the vehicle contract service fee and vehicle release service fee can increase, for example.

An embodiment of the present disclosure can minimize the existing complex vehicle purchase process, and reduce the accumulation of complaints when a vehicle is selected with a wrong decision. Furthermore, an embodiment of the present disclosure can identify the tendency of the user, match the vehicle tendency with the tendency of the user, determine the vehicle suitable for the tendency of the user, and be made in one-stop until delivery.

The vehicle recommendation system according to an embodiment of the present disclosure can establish a new car sales platform formed based on conventional discounts in a new way, and provide time benefits and monetary benefits to vehicle sales dealers (hereinafter referred to as car masters) and users.

In addition, the vehicle recommendation system according to an embodiment of the present disclosure can recommend the optimal vehicle to the user based on the tendency of the user, thereby improving user satisfaction with the vehicle recommendation system and improving the brand image of the vehicle purchased by the user. When the tendency of the user is identified, everyday questions can be used without directly asking questions about cars, and thus, it is possible to provide the user with an opportunity to purchase the optimal vehicle that can meet the tendency of the user even if the user does not know the car well.

In addition, a business model can be developed using a platform built by the vehicle recommendation system, and thus, users, car masters, and platform entrepreneurs can make profits reasonably.

Although embodiments of the present disclosure have been described in detail above, the scope of the present disclosure is not limited thereto, and various modifications and improvements of those skilled in the art using the basic concept of the present disclosure defined in the following claims also fall within the scope of the present disclosure.

While embodiments have been described with reference to specific illustrative embodiments and examples, this description is not intended to be construed in a limiting sense. Various modifications and combinations of the illustrative embodiments, as well as other embodiments, can be apparent to persons skilled in the art upon reference to the description. It is therefore intended that the appended claims encompass any such modifications or embodiments.

What is claimed is:

1. A vehicle recommendation system comprising:
a user tendency determiner configured to determine a user tendency and a trim tendency of a user corresponding to the user tendency based on a response to a user tendency test received from a user terminal;
a price index calculation unit configured to, with respect to a plurality of vehicles, derive a price index of each vehicle based on a price of each vehicle and a vehicle purchase budget of the user; and
an optimal tendency matcher configured to derive, as a plurality of candidate vehicles, vehicles conforming the trim tendency of the user and having the price index equal to or greater than a predetermined critical price index, among the plurality of vehicles, based on at least the trim tendency of the user and the price index.

2. The vehicle recommendation system of claim 1, wherein the optimal tendency matcher is configured to derive the plurality of candidate vehicles based on an estimated number of passengers together with the trim tendency of the user and the price index, and
wherein the estimated number of passengers is received from the user terminal.

3. The vehicle recommendation system of claim 1, wherein the optimal tendency matcher comprises a leveling index calculator configured to calculate a plurality of leveling indexes for leveling a plurality of indexes of a plurality of vehicle tendency elements of each candidate vehicle with respect to the plurality of candidate vehicles.

4. The vehicle recommendation system of claim 3, wherein the optimal tendency matcher further comprises a matching index calculator configured to calculate a tendency matching index, the tendency matching index being a matching index between a result of applying a plurality of leveling indexes to a vehicle tendency of each candidate vehicle with respect to the plurality of candidate vehicles and the user tendency.

5. The vehicle recommendation system of claim 4, wherein the matching index calculator is configured to calculate a plurality of fourth indexes by correspondingly multiplying a plurality of third indexes, obtained by multiplying the plurality of leveling indexes by a plurality of second indexes for a plurality of vehicle tendency elements corresponding to the vehicle tendency of each candidate vehicle, by a plurality of first indexes for a plurality of user tendency elements corresponding to the user tendency.

6. The vehicle recommendation system of claim 5, wherein the optimal tendency matcher further comprises a weight applicator configured to calculate a tendency matching index by applying at least one weight according to each candidate vehicle with respect to a plurality of candidate vehicles to the plurality of fourth indexes of each candidate vehicle.

7. The vehicle recommendation system of claim 6, wherein the weight applicator is configured to apply a weight according to a trim tendency of each candidate vehicle with respect to the plurality of candidate vehicles to the fourth index of the corresponding vehicle tendency element among the plurality of fourth indexes of each candidate vehicle.

8. The vehicle recommendation system of claim 7, wherein the weight applicator is configured to calculate a total index by summing the plurality of fourth indexes to which the weight according to the trim tendency of each candidate vehicle is applied with respect to the plurality of candidate vehicles.

9. The vehicle recommendation system of claim 8, wherein the weight applicator is configured to calculate the tendency matching index by adding a camping factor index and a passenger factor index to the total index, the camping factor index being an index set in response to each candidate vehicle being a vehicle suitable for camping, and the passenger factor index being an index set according to a number of passengers ridable in each candidate vehicle.

10. The vehicle recommendation system of claim 1, wherein the optimal tendency matcher is configured to determine a plurality of purchase target vehicles based on a tendency matching index indicating a degree of matching between the user tendency and the vehicle tendency of each of the plurality of candidate vehicles.

11. The vehicle recommendation system of claim 1, further comprising an age index calculator configured to derive an age index for an age of a user predicted to purchase each vehicle with respect to the plurality of vehicles in consideration of a segment, a brand, a type, and an energy source of each vehicle.

12. A vehicle recommendation system comprising:
a user tendency determiner configured to determine a user tendency and a trim tendency of a user corresponding to the user tendency based on a response to a user tendency test received from a user terminal;
a price index calculation unit configured to, with respect to a plurality of vehicles, derive a price index of each vehicle based on a price of each vehicle and a vehicle purchase budget of the user;
an optimal tendency matcher configured to derive, as a plurality of candidate vehicles, vehicles conforming the trim tendency of the user and having the price index equal to or greater than a predetermined critical price index, among the plurality of vehicles, based on at least the trim tendency of the user and the price index, wherein the plurality of candidate vehicles includes a vehicle to be determined whether it is suitable for recommendation to the user as a purchase vehicle; and
a car master selector configured to identify a plurality of candidate car masters selling a purchase target vehicle selected through the user terminal among the plurality of candidate car masters, and configured to select a final car master suitable for the user from among the plurality of candidate car masters.

13. The vehicle recommendation system of claim 12, wherein the car master selector is configured to select the final car master using one of or a combination of a tendency matching method of selecting a car master conforming the user tendency, a distance reference method of selecting a car master located within a certain distance with respect to a user location, and a customer evaluation reference method of selecting a car master of which evaluation score based on a customer evaluation is equal to or greater than a predetermined reference score.

14. The vehicle recommendation system of claim 13, wherein the car master selector is configured to calculate a standard deviation of a difference between the plurality of tendency elements of each candidate car master and the plurality of tendency elements of the user with respect to the plurality of candidate car masters according to the tendency matching method and select a car master corresponding to a smallest standard deviation among a plurality of standard deviations as the final car master.

15. The vehicle recommendation system of claim 13, wherein the car master selector is configured to select a candidate car master located within a predetermined reference distance from among a plurality of candidate car masters as a final car master with respect to a location designated by the user according to the distance reference method.

16. The vehicle recommendation system of claim 13, wherein the car master selector is configured to calculate an evaluation score based on customer evaluations of the plurality of candidate car masters, and configured to select a candidate car master of which evaluation score is equal to or higher than a predetermined reference score as a final car master according to the customer evaluation reference method.

17. The vehicle recommendation system of claim 12, wherein the vehicle recommendation system charges a corresponding fee for one of or a combination of a test drive service, a vehicle contract service, and a vehicle delivery service from the final car master.

18. The vehicle recommendation system of claim 17, further comprising a fee calculator configured to calculate a fee for a service provided to a user from the final car master, wherein the fee calculator is configured to calculate a fee ratio between two services linked based on a linkage ratio between the two services being linked among the test drive service, the vehicle contract service, and the vehicle delivery service.

19. The vehicle recommendation system of claim 18, wherein the fee calculator is configured to reduce a test drive service fee and a vehicle contract service fee based on a first linkage ratio between the test drive service and the vehicle contract service of each of the plurality of car masters, and reduce the vehicle contract service fee and a vehicle delivery service fee based on a second linkage ratio between the vehicle contract service and the vehicle delivery service.

20. The vehicle recommendation system of claim 19, wherein the vehicle recommendation system is configured to, in response to the first linkage ratio being increased, increase a range of reduction of the test drive service fee and the vehicle contract service fee, and in response to the second linkage ratio being increased, increase a range of reduction of the vehicle contract service fee and vehicle release service fee.
